(19) United States
(12) Patent Application Publication
(10) Pub. No.: US 2026/0098731 A1
(43) Pub. Date: Apr. 9, 2026

(54) ROUTE GUIDANCE TERMINAL, ROUTE GUIDANCE SYSTEM, AND ROUTE GUIDANCE METHOD

(71) Applicant: DABEEO, INC., Seoul (KR)

(72) Inventor: Ju Hum Park, Seoul (KR)

(73) Assignee: DABEEO, INC., Seoul (KR)

(21) Appl. No.: 19/114,315

(22) PCT Filed: Mar. 17, 2023
(86) PCT No.: PCT/KR2023/003603

§ 371 Date: Mar. 21, 2025

(30) Foreign Application Priority Data
Sep. 22, 2022 (KR) 10-2022-0120118

(51) Int. Cl. G01C 21/20; G01C 21/00

(52) U.S. Cl. CPC G01C 21/206; G01C 21/005

(57) ABSTRACT

A route guidance terminal of the present invention comprises: a user interface unit; a camera which captures an image of a marker installed indoors; and a terminal processor which recognizes the marker from the image captured by the camera and transmits identification information of the marker to a route guidance system, receives a current location of a user, transmitted from the route guidance system, the current location being extracted on the basis of the identification information, and outputs the current location through the user interface unit.

### TECHNICAL FIELD

The present invention relates to a route guidance terminal, a route guidance system, and a route guidance method.

### BACKGROUND ART

Indoor location measurement technology may provide conveniences such as location-based services (LBSs) in various situations such as those encountered in large department stores, hospitals, and office buildings.

Accordingly, many studies are being conducted on indoor location measurement technology.

Conventional indoor location measurement technology includes simultaneous localization and mapping (SLAM).

SLAM is a method of extracting features for an entire space using traditional image processing techniques, constructing a map model for the entire space, and using the map model to estimate a location.

However, SLAM is difficult to use for mobile devices such as smartphones and the like because the information storage capacity for spatial modeling is large.

Further, in SLAM, when tracking fails, information on an entire space is searched to estimate a current location, and thus a location processing speed is slow.

Further, SLAM has a problem of low user accessibility because it uses equipment for collecting three-dimensional (3D) point clouds, such as LiDAR, stereo vision, etc., for accurate spatial modeling.

The related art of the present invention is disclosed in “LiDAR Data Modeling Method and System for Constructing 3D Indoor Spatial Information” of Korean Patent Registration No. 10-1525891 (Published on May 29, 2015).

### DISCLOSURE

### Technical Problem

The present invention is directed to providing a technique for, when a marker installed indoors is recognized through a mobile terminal, extracting a user's current location on the basis of a location of the recognized marker and mapping a route from the user's current location to a destination onto an electronic map to guide the user along the route.

### Technical Solution

One aspect of the present disclosure provides a route guidance terminal which includes a user interface unit, a camera configured to capture an image of a marker installed indoors, and a terminal processor which, when the marker is recognized in the image captured by the camera, transmits identification information of the marker to a route guidance system to receive an electronic map from the route guidance system, and when a destination is input through the user interface unit, searches for a route to the destination and displays a route identified through the search on the electronic map through the user interface unit.

The terminal processor of the present invention may provide guidance on correcting a pose of the camera through the user interface unit in the process of controlling the camera to capture the image of the marker.

The pose of the camera of the present invention may include at least one of a distance between the camera and the marker, a location of the camera, an angle of the camera, a magnification of the camera, a photographing time of the camera, and a screen brightness of the camera.

The terminal processor of the present invention may analyze the image captured through the camera to detect the identification information of the marker, detect a location of the marker matching the identification information of the marker from the electronic map, and then measure a relative location with respect to the route guidance terminal based on the location of the marker to measure a current location of the route guidance terminal.

The present invention may further include a measurement unit configured to measure a moving direction and distance of the route guidance terminal, wherein the terminal processor may search for a route to the destination on the basis of the moving direction and distance of the route guidance terminal that are measured by the measurement unit, and output a route identified through the search through the user interface unit.

The terminal processor of the present invention may re-search for the route according to whether the route guidance terminal goes out of a preset route range on the basis of the moving direction and distance of the route guidance terminal, and output a route identified through the re-search through the user interface unit.

The terminal processor of the present invention may receive content from the route guidance system and display the received content through the user interface unit.

The content of the present invention may include at least one of point of interest (POI) information, text information, coupon information, and product information.

The terminal processor of the present invention may receive a keyword through the user interface unit, search for the content, and output the content identified through the search through the user interface unit.

The terminal processor of the present invention may select content for which guidance is available on the electronic map based on a current location of the route guidance terminal and display the selected content through the user interface unit.

Another aspect of the present disclosure provides a route guidance system which includes a database unit configured to store information for route guidance of a route guidance terminal, and a system processor which, upon receiving identification information of a marker installed indoors from the route guidance terminal, transmits an electronic map and content from the database unit to the route guidance terminal on the basis of identification information.

Still another aspect of the present disclosure provides a route guidance method which includes capturing, by a route guidance terminal, an image of a marker installed indoors and recognizing the marker in the captured image, transmitting, by the route guidance terminal, identification information of the marker to a route guidance system and receiving an electronic map from the route guidance system, and receiving, by the route guidance terminal, a destination, searching for the route from the current location to the destination, and outputting the route identified through the search.

In the recognizing of the marker of the present invention, the route guidance terminal may provide guidance on correcting a pose of an internal camera.

The pose of the camera of the present invention may include at least one of a distance between the camera and the marker, a location of the camera, an angle of the camera, a magnification of the camera, a photographing time of the camera, and a screen brightness of the camera.

In the searching for the route from the current location to the destination and outputting the route identified through the search of the present invention, the route guidance terminal may analyze an image captured through a camera to detect the identification information of the marker, detect a location of the marker matching the identification information of the marker from the electronic map, and then measure a relative location with respect to the route guidance terminal based on the location of the marker to measure the current location of the route guidance terminal.

In the searching for the route from the current location to the destination and outputting the route identified through the search of the present invention, the route guidance terminal may search for a route to the destination on the basis of a moving direction and distance of the route guidance terminal and output the route identified through the search.

In the searching for the route from the current location to the destination and outputting the route identified through the search of the present invention, the route may be re-searched for according to whether the route guidance terminal goes out of a preset route range on the basis of the moving direction and distance of the route guidance terminal, and the route identified through the re-search may be output.

The present invention may further include receiving, by the route guidance terminal, content from the route guidance system and outputting the received content.

The content of the present invention may include at least one of POI information, text information, coupon information, and product information.

In the receiving of the content from the route guidance system and outputting the received content of the present invention, the route guidance terminal may receive a keyword, search for the content, and output the content identified through the search.

In the receiving of the content from the route guidance system and outputting the received content of the present invention, the route guidance terminal may select content for which guidance is available on the electronic map based on the current location of the route guidance terminal and display the selected content.

### Advantageous Effects

According to the present invention, when a marker installed indoors is recognized through a mobile terminal, it is possible to extract a user's current location on the basis of a location of the recognized marker and map a route from the user's current location to a destination onto an electronic map to guide the user along the route.

The present invention has a simple process for linking an electronic map and service, and thus the cost of system construction and maintenance can be lowered.

The present invention is web-based, and thus there is no need to install an application on a user terminal separately, thereby increasing user accessibility and convenience.

### DESCRIPTION OF DRAWINGS

FIG. 1 is a block diagram of a route guidance terminal and a route guidance system according to one embodiment of the present invention.

FIG. 2 is a set of diagrams showing examples of a marker according to one embodiment of the present invention.

FIG. 3 is a screen for providing guidance on marker photographing according to one embodiment of the present invention.

FIG. 4 is a diagram showing an example of measuring a relative location of a route guidance terminal based on a marker according to one embodiment of the present invention.

FIG. 5 is a diagram showing an example of measuring a relative location of a route guidance terminal based on a marker according to one embodiment of the present invention.

FIG. 6 is a screen showing a current location of a route guidance terminal according to one embodiment of the present invention.

FIG. 7 is a screen showing a moving route of a route guidance terminal according to one embodiment of the present invention.

FIG. 8 is a diagram showing an example of indicating a location on a route according to one embodiment of the present invention.

FIG. 9 is a set of screens showing a process of providing content information and route guidance according to one embodiment of the present invention.

FIG. 10 is a flowchart of a route guidance method according to one embodiment of the present invention.

### BEST MODE OF THE INVENTION

Hereinafter, embodiments of a route guidance terminal, a route guidance system, and a route guidance method according to the present invention will be described with reference the accompanying drawings. In this process, thicknesses of lines, sizes of components, and the like illustrated in the drawings may be exaggerated for clarity and convenience of description. Further, some terms which will be described below are defined in consideration of functions in the present invention and meanings may vary depending on, for example, a user or operator's intentions or customs. Therefore, the meanings of these terms should be interpreted based on the scope throughout this specification.

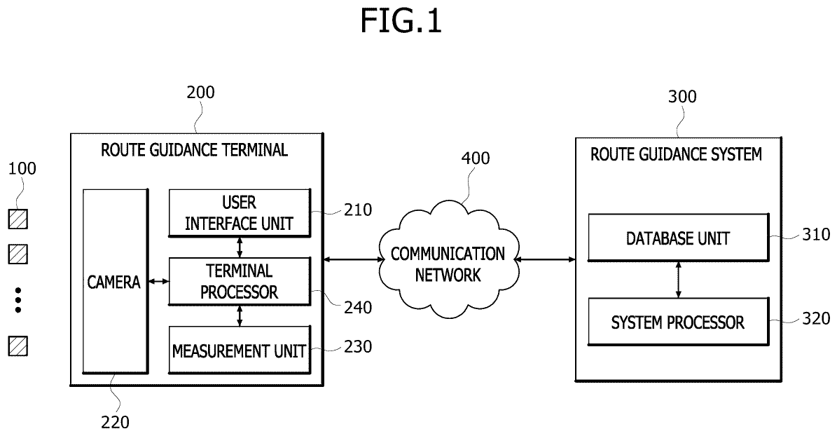

FIG. 1 is a block diagram of a route guidance terminal and a route guidance system according to one embodiment of the present invention.

Referring to FIG. 1, a route guidance terminal 200 provides an indoor route guidance service to a user in conjunction with a route guidance system 300.

The route guidance terminal 200 includes a camera 220, a user interface unit 210, a measurement unit 230, and a terminal processor 240.

The camera 220 captures an image of a marker 100 and inputs the captured image into the terminal processor 240.

The marker 100 is installed as a plurality of markers 100 at various points indoors.

The points at which the markers 100 are installed may be indoor walls or facilities, but the present invention is not particularly limited thereto.

Unique identification information is stored in each marker 100.

The identification information may be location coordinates or unique information assigned to the corresponding marker 100.

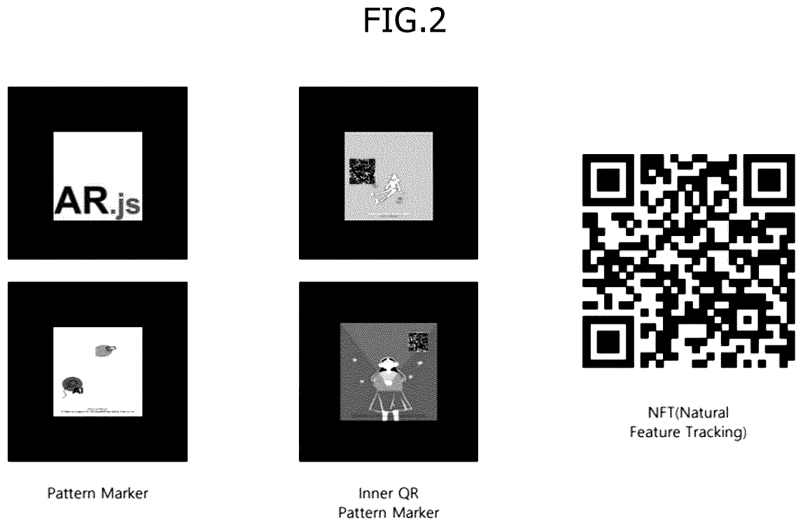

FIG. 2 is a set of diagrams showing examples of the marker according to one embodiment of the present invention.

Referring to FIG. 2, the markers 100 may include pattern markers, quick response (QR) pattern markers, or natural feature tracking (NFT).

The marker 100 may be printed on a printed sheet or sticker to be attached to or detached from an indoor wall or facility. Therefore, a manager may attach or detach the markers 100 to or from various locations as necessary.

The markers 100 may include pattern markers, QR pattern markers, or NFT, as described above, or the markers 100 may be attached to or detached from sculptures, facilities, staircases, store signs, etc., installed at each location indoors, but the present invention is not particularly limited thereto.

The user interface unit 210 provides a user interface to the user. For example, information for photographing markers for route guidance, providing menus, entering destinations, providing route guidance, etc., is input or output through the user interface unit 210

The measurement unit 230 measures a moving direction and distance of the route guidance terminal 200.

Any sensor capable of tracking the movement of a moving object, such as a gyro sensor, an inertial sensor, or the like, may be employed as the measurement unit 230.

The terminal processor 240 recognizes the marker 100 from the image captured through the camera 220, detects identification information from the recognized marker 100, and transmits the detected identification information to the route guidance system 300 through a communication network 400.

The communication network 400 performs data communication between the route guidance terminal 200 and the route guidance system 300.

3rd Generation Partnership Project (3GPP), Long Term Evolution (LTE), 5th generation (5G), World Interoperability for Microwave Access (WIMAX), wired and wireless Internet, a local area network (LAN), a wireless LAN, a wide area network (WAN), a personal area network (PAN), Bluetooth, Wi-Fi, etc., may be employed as the communication network 400, but the present invention is not particularly limited thereto.

The terminal processor 240 receives an electronic map and content from the route guidance system 300.

The terminal processor 240 extracts a current location of the user on the basis of the electronic map received from the route guidance system 300 and outputs the current location of the user on the electronic map through the user interface unit 210.

Further, the terminal processor 240 provides various content to the user through the user interface unit 210.

More specifically, the terminal processor 240 receives a camera photographing command through the user interface. When the camera photographing command is input, the terminal processor 240 guides the user to capture an image of the marker 100 through the user interface unit 210.

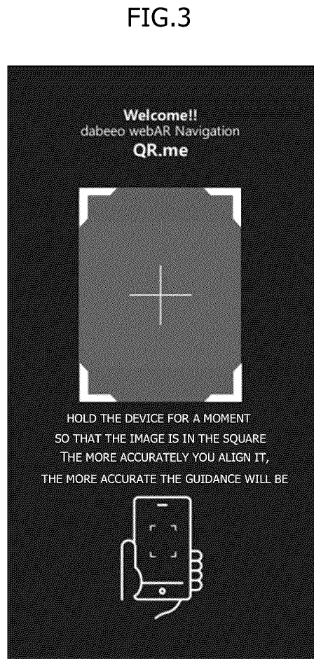

FIG. 3 is a screen for providing guidance on marker photographing according to one embodiment of the present invention.

Referring to FIG. 3, the terminal processor 240 forms a block on a screen of the user interface unit 210 and provides guidance on positioning the marker 100 within the block.

When the marker 100 is positioned within the block at an appropriate size by the user's manipulation, the terminal processor 240 controls the camera 220 to capture the image of the marker 100. The camera 220 inputs the captured image into the terminal processor 240.

In the process of controlling the camera 220 to capture the image of the marker 100, the terminal processor 240 may provide guidance on correcting the pose of the camera 220 through the user interface unit 210, thereby increasing a recognition rate of the marker 100. For example, the terminal processor 240 may provide guidance on at least one of a distance between the camera 220 and the marker 100, a location of the camera 220, an angle of the camera 220, a magnification of the camera 220, a photographing time of the camera 220, and a screen brightness of the camera 220 as the pose of the camera 220.

That is, a preset setting range is set to each of the distance between the camera 220 and the marker 100, the location of the camera 220, the angle of the camera 220, the magnification of the camera 220, the photographing time of the camera 220, and the screen brightness of the camera 220, and the terminal processor 240 guides the user through the user interface unit 210 to cause each of the distance between the camera 220 and the marker 100, the location of the camera 220, the angle of the camera 220, the magnification of the camera 220, the photographing time of the camera 220, and the screen brightness of the camera 220 to be within the corresponding setting range. Accordingly, the user may correct the pose of the camera 220.

The terminal processor 240 analyzes the image input from the camera 220 to recognize the marker 100, detects identification information of the marker 100, and transmits the detected identification information to the route guidance system 300.

The terminal processor 240 receives an electronic map and content including a location of the marker 100 from the route guidance system 300, and detects a location of the marker 100 matching the identification information of the marker 100 from the corresponding electronic map.

The terminal processor 240 measures a relative location with respect to the route guidance terminal 200 based on the location of the marker 100.

The locations of the marker 100 and route guidance terminal 200 do not actually match. This is because the user captures the image of the marker 100 at a location away from the marker 100 while holding the route guidance terminal 200.

Here, the route guidance terminal 200 may capture images of the marker 100 in various directions while spaced away from the marker 100. Therefore, an actual location of the route guidance terminal 200 may be detected based on the marker 100 recognized according to the image captured by the camera 220.

That is, the terminal processor 240 analyzes the image, and when the marker 100 is recognized, the terminal processor 240 measures the relative location of the route guidance terminal 200 based on the location of the marker 100. The location of the marker 100 may be received from the route guidance system 300.

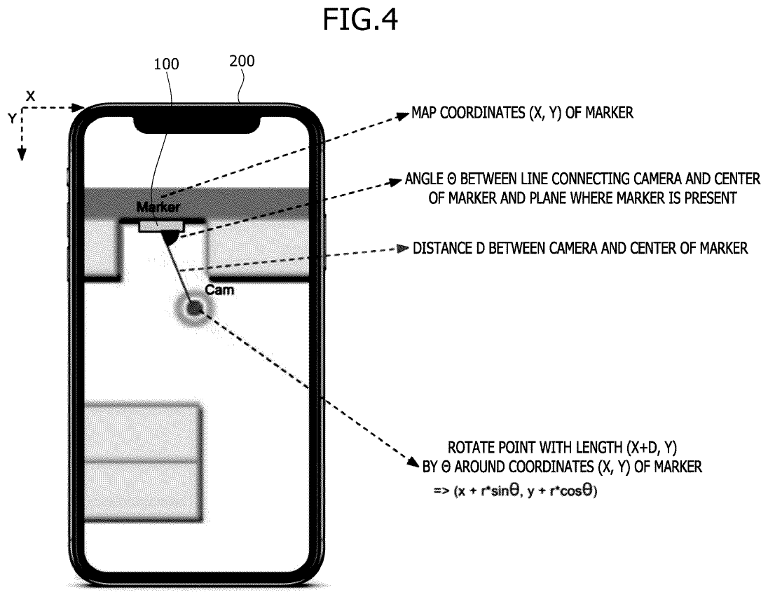

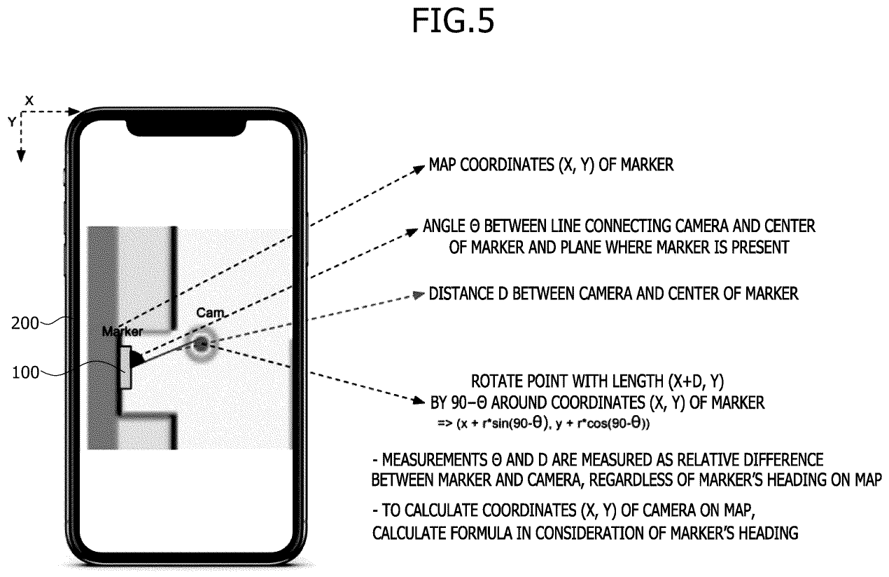

FIGS. 4 and 5 are diagrams showing examples of measuring a relative location of a route guidance terminal based on a marker according to one embodiment of the present invention.

Referring to FIGS. 4 and 5, when it is assumed that a location of the marker 100 corresponds to coordinates (x, y), the terminal processor 240 analyzes an image to detect a relative location of the route guidance terminal 200. The relative location of the route guidance terminal 200 may include an angle θ formed by a line connecting the camera 220 and the center of the marker 100 and a plane on which the marker 100 is present, and a distance d between the camera 220 and the center of the marker 100.

In this case, the terminal processor 240 may measure a current location (x+r*sinθ, y+r*cosθ) of the route guidance terminal 200 using the location and relative location of the marker 100.

Further, even when a point with a length (x+d, y) is rotated by 90−θ (=270+θ) around the coordinates of the marker 100, the terminal processor 240 may measure a current location (x+r*sin(90−θ), y+r*cos(90−θ)) of the route guidance terminal 200.

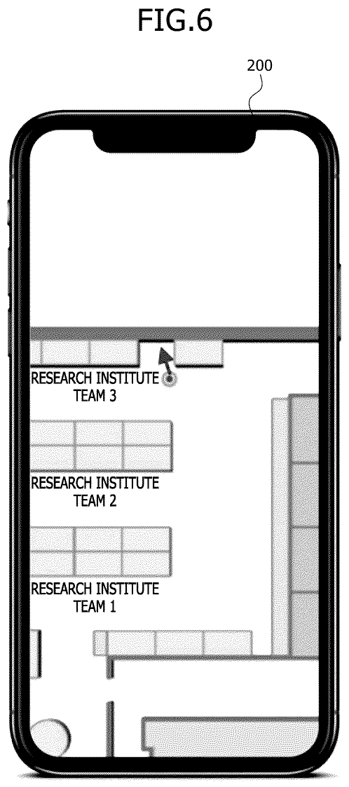

FIG. 6 is a screen showing a current location of a route guidance terminal according to one embodiment of the present invention.

Referring to FIG. 6, it can be seen that the location of the route guidance terminal 200 is displayed on the screen of the user interface unit 210 and is different from the marker 100 attached to an actual wall.

Meanwhile, the terminal processor 240 receives a destination through the user interface unit 210.

Thereafter, the terminal processor 240 searches for a route from the current location of the route guidance terminal 200 to the destination and outputs a route identified through the search through the user interface unit 210. In this case, the terminal processor 240 matches the above-described route to an electronic map and outputs a result of the matching. The form of the electronic map is not particularly limited.

In the process of providing guidance on the route to the destination, the terminal processor 240 measures a moving direction and distance of the route guidance terminal 200 through the measurement unit 230, re-searches for the route to the destination on the basis of the measured moving direction and distance, and outputs a route identified through the re-search through the user interface unit.

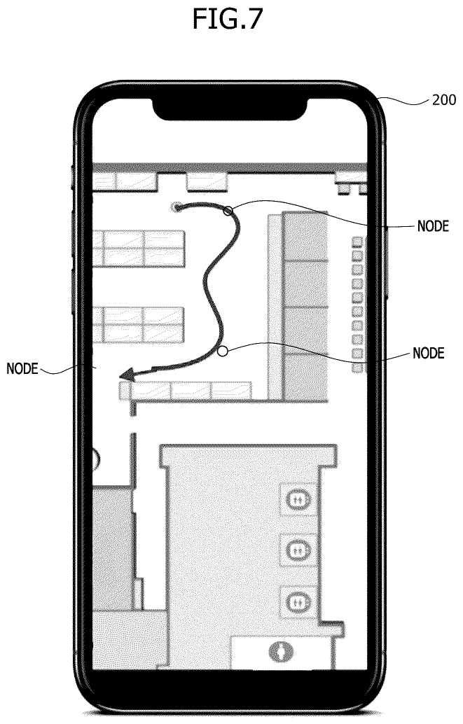

FIG. 7 is a screen showing a moving route of a route guidance terminal according to one embodiment of the present invention.

In FIG. 7, a user's moving route identified through a search based on the moving direction and distance of the route guidance terminal 200 that are measured by the measurement unit 230 is shown.

Meanwhile, as described above, in the process of providing guidance on the route to the destination, the terminal processor 240 determines whether the current location of the route guidance terminal 200 is out of a route range. The terminal processor 240 determines whether the current location of the route guidance terminal 200 is within the route range through the moving direction and distance of the route guidance terminal 200 that are measured by the measurement unit 230.

When it is determined that the current location of the route guidance terminal 200 is out of the route range, the terminal processor 240 re-searches for the route and outputs a route identified through the re-search through the user interface unit 210.

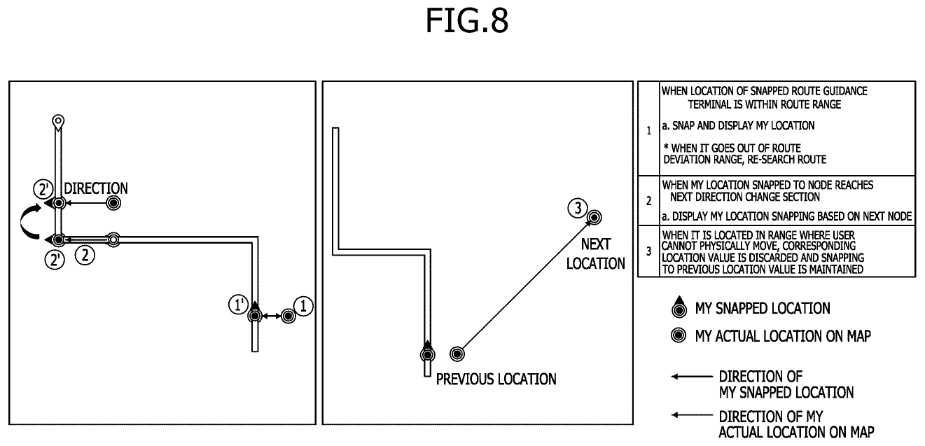

FIG. 8 is a diagram showing an example of indicating a location on a route according to one embodiment of the present invention.

Referring to FIG. 8, when it is determined that the current location of the route guidance terminal 200 is within the route range, the terminal processor 240 displays the current location of the route guidance terminal 200 by snapping (1->1′).

Further, when the location of the snapped route guidance terminal 200 reaches a next direction change section, the terminal processor 240 snaps and displays the location of the route guidance terminal 200 based on another node (2->2′).

When the route guidance terminal 200 is in a range where the user cannot physically move, the terminal processor 240 maintains the snapping with the previous location value and displays the snapping (3).

Meanwhile, the terminal processor 240 selects content for which guidance is available on the electronic map based on the current location of the route guidance terminal 200 from among content received from the route guidance system 300, and displays the selected content through the user interface unit 210.

The content may include point of interest (POI) information, text information, coupon information, and product information, but the present invention is not particularly limited thereto.

The terminal processor 240 may provide a route guidance service on the basis of the above-described content. That is, the terminal processor 240 may set a POI as the destination and guide the user along the route from the current location to the POI.

Further, the terminal processor 240 receives a keyword for content search through the user interface unit 210, searches for the content on the basis of the keyword, and outputs the content identified through the search through the user interface unit 210.

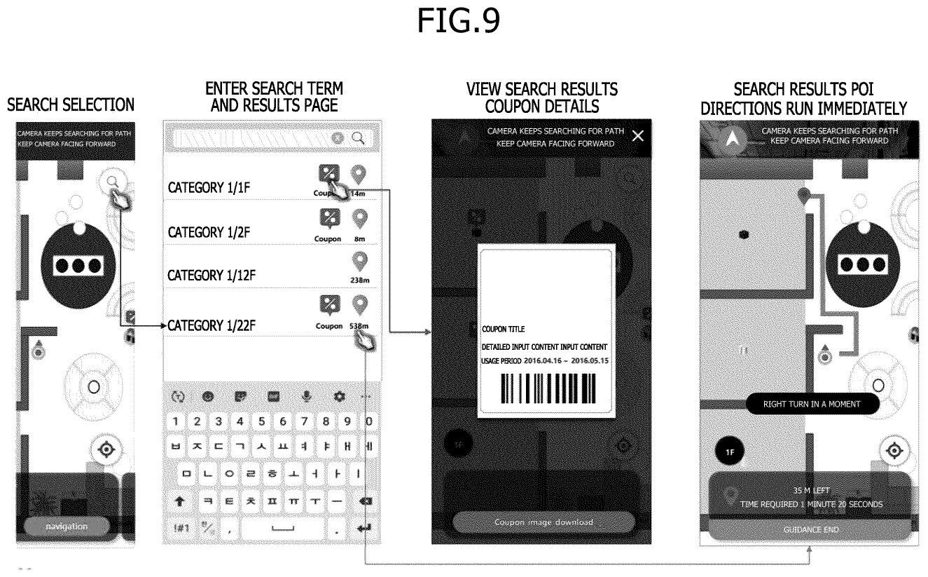

FIG. 9 is a set of screens showing a process of providing content information and route guidance according to one embodiment of the present invention.

When a keyword search is performed as shown in FIG. 9A, the terminal processor 240 displays a keyword search window as shown in FIG. 9B. In this case, the terminal processor 240 receives the keyword and searches for the content through the keyword. Next, the terminal processor 240 displays a result of the content search.

Thereafter, when the result of the content search is selected, the terminal processor 240 outputs content, such as a coupon, according to the selected keyword search result through the user interface unit 210 as shown in FIG. 9C.

Next, when a POI is selected as the destination, the terminal processor 240 searches for a route using the corresponding POI as the destination, and outputs the route to the POI through the user interface unit 210 as shown in FIG. 9D.

Here, as the route guidance terminal 200, any device that can be carried by users, such as a smartphone, a laptop computer, a personal digital assistant (PDA), etc., and that can provide the users with various user interfaces, receive and process various information, and transmit or receive information to or from various external systems via wired or wireless Internet may be employed.

When the route guidance system 300 receives identification information of a marker 100 installed indoors from the route guidance terminal 200, a database unit 310 transmits an electronic map and content to the route guidance terminal 200 on the basis of the identification information.

Referring to FIG. 1, the route guidance system 300 includes the database unit 310 and a system processor 320.

The database unit 310 stores information for route guidance of the route guidance terminal 200 and content.

The information for route guidance may include identification information and location information for each marker 100, and an electronic map. In addition, various information for route guidance may be included.

The content may include POI information, text information, coupon information, and product information.

When the identification information is transmitted from the route guidance terminal 200 through the communication network 400, the system processor 320 extracts an electronic map corresponding to the corresponding identification information and content provided based on the electronic map from the database unit 310, and transmits the extracted electronic map and content to the route guidance terminal 200 through the communication network 400.

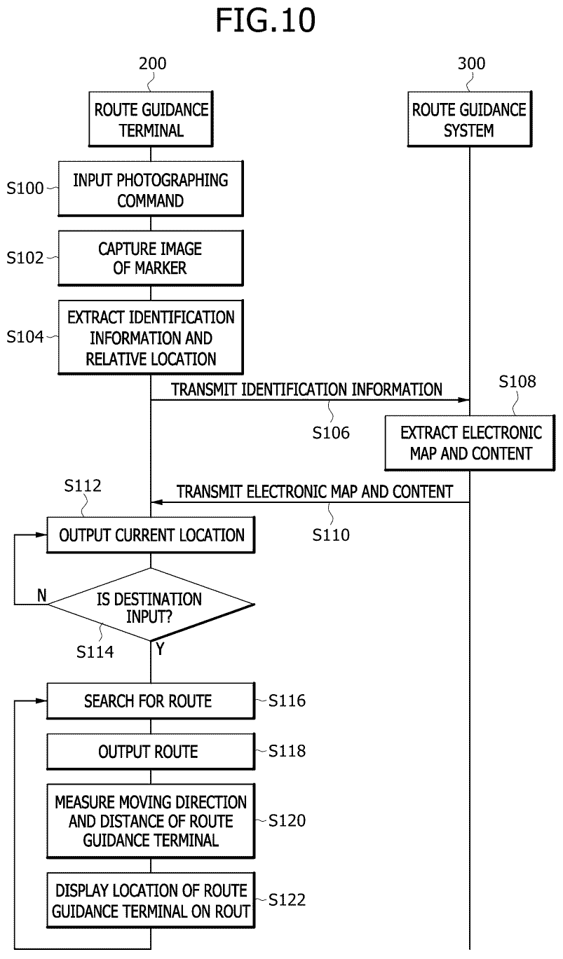

Hereinafter, a route guidance method according to one embodiment of the present invention will be described with reference to FIG. 10.

FIG. 10 is a flowchart of the route guidance method according to one embodiment of the present invention.

Referring to FIG. 10, a terminal processor 240 receives a camera photographing command from a user through a user interface unit 210 (S100).

When a camera photographing command is input, the terminal processor 240 guides the user to capture an image of a marker 100 through the user interface unit 210. When the marker 100 is positioned within a block on a screen of the user interface unit 210 at an appropriate size, the terminal processor 240 controls a camera 220 to capture the image of the marker 100 (S102). The camera 220 inputs the captured image into the terminal processor 240.

The terminal processor 240 recognizes the marker 100 from the image input from the camera 220 and detects identification information of the marker 100 (S104).

The terminal processor 240 transmits the identification information of the marker 100 to a route guidance system 300 through a communication network 400 (S106).

A system processor 320 of the route guidance system 300 extracts an electronic map corresponding to the identification information of the marker 100 and content that can be provided based on the electronic map in a database unit 310 (S108), and transmits the extracted electronic map and content to a route guidance terminal 200 (S110).

Meanwhile, the terminal processor 240 detects a location of the marker 100 matching the identification information of the marker 100 from the electronic map.

Next, the terminal processor 240 detects a relative location of the route guidance terminal 200 on the basis of the location of the marker 100. The terminal processor 240 detects a current location of the route guidance terminal 200 on the basis of the relative location of the route guidance terminal 200 based on the location of the marker 100, and outputs the detected current location of the route guidance terminal 200 through the user interface unit 210 (S112).

In this process, the terminal processor 240 determines whether a destination is input through the user interface unit 210 (S114).

When it is determined that the destination is input in operation S114, the terminal processor 240 searches for a route from the current location of the route guidance terminal 200 to the destination (S116), and outputs a route identified through the search (S118).

In this case, the terminal processor 240 measures a moving direction and distance of the route guidance terminal 200 through a measurement unit 230 (S120), and outputs the current location of the route guidance terminal 200 on the basis of the moving direction and distance of the route guidance terminal 200 (S122).

Meanwhile, as the moving direction and distance of the route guidance terminal 200 change, the terminal processor 240 searches for a route to the destination and outputs a route identified through the search (S116 and S118). The terminal processor 240 performs the above-described process repeatedly until the route guidance terminal 200 reaches the destination or the route guidance ends.

Meanwhile, the terminal processor 240 may search for content based on the current location of the route guidance terminal 200 and output content identified through the search during the process of providing route guidance as described above.

Further, the terminal processor 240 receives a keyword through the user interface unit 210, searches for content on the basis of the corresponding keyword, and outputs the content identified through the search.

Thereafter, when a POI is set as the destination, the terminal processor 240 re-searches for a route from the current location to the POI and outputs a route identified through the re-search.

In this way, in one embodiment of the present invention, when a marker installed indoors is recognized through a mobile terminal, it is possible to extract a user's current location on the basis of a location of the recognized marker and map a route from the user's current location to a destination onto an electronic map to guide the user along the route.

Further, one embodiment of the present invention has a simple process for linking an electronic map and service, and thus the cost of system construction and maintenance can be lowered.

Further, one embodiment of the present invention is web-based, and thus there is no need to install an application on a user terminal separately, thereby increasing user accessibility and convenience.

The implementations described herein may be implemented, for example, as methods or processes, devices, software programs, data streams, or signals. Even when discussed only in the context of a single form of implementation (e.g., discussed only as a method), the implementation of the discussed features may also be implemented in other forms (e.g., as a device or program). The device may be implemented with appropriate hardware, software, firmware, etc. The method may be implemented in a device such as a processor, which generally refers to a processing device including, for example, a computer, a microprocessor, an integrated circuit, a programmable logic device, or the like. The processor also includes a communication device such as a computer, a cellular phone, a PDA, and other devices that facilitate communication of information between end-users.

While the present invention has been described with reference to embodiments illustrated in the accompanying drawings, the embodiments should be considered in a descriptive sense only, and it should be understood by those skilled in the art that various alterations and equivalent other embodiments may be made. Therefore, the scope of the present invention should be defined only by the following claims.

1. A route guidance terminal comprising:
a user interface unit;
a camera configured to capture an image of a marker installed indoors; and
a terminal processor which, when the marker is recognized in the image captured by the camera, transmits identification information of the marker to a route guidance system to receive an electronic map from the route guidance system, and when a destination is input through the user interface unit, searches for a route to the destination and displays a route identified through the search on the electronic map through the user interface unit.

2. The route guidance terminal of claim 1, wherein the terminal processor provides guidance on correcting a pose of the camera through the user interface unit in the process of controlling the camera to capture the image of the marker.

3. The route guidance terminal of claim 2, wherein the pose of the camera includes at least one of a distance between the camera and the marker, a location of the camera, an angle of the camera, a magnification of the camera, a photographing time of the camera, and a screen brightness of the camera.

4. The route guidance terminal of claim 1, wherein the terminal processor analyzes the image captured through the camera to detect the identification information of the marker, detects a location of the marker matching the identification information of the marker from the electronic map, and then measures a relative location with respect to the route guidance terminal based on the location of the marker to measure a current location of the route guidance terminal.

5. The route guidance terminal of claim 1, further comprising a measurement unit configured to measure a moving direction and distance of the route guidance terminal,
wherein the terminal processor searches for a route to the destination on the basis of the moving direction and distance of the route guidance terminal that are measured by the measurement unit, and outputs a route identified through the search through the user interface unit.

6. The route guidance terminal of claim 5, wherein the terminal processor re-searches for the route according to whether the route guidance terminal goes out of a preset route range on the basis of the moving direction and distance of the route guidance terminal, and outputs a route identified through the re-search through the user interface unit.

7. The route guidance terminal of claim 1, wherein the terminal processor receives content from the route guidance system and displays the received content through the user interface unit.

8. The route guidance terminal of claim 7, wherein the content includes at least one of point of interest (POI) information, text information, coupon information, and product information.

9. The route guidance terminal of claim 7, wherein the terminal processor receives a keyword through the user interface unit, searches for the content, and outputs the content identified through the search through the user interface unit.

10. The route guidance terminal of claim 7, wherein the terminal processor selects content for which guidance is available on the electronic map based on a current location of the route guidance terminal and displays the selected content through the user interface unit.

11. A route guidance system comprising:
a database unit configured to store information for route guidance of a route guidance terminal; and
a system processor which, upon receiving identification information of a marker installed indoors from the route guidance terminal, transmits an electronic map and content from the database unit to the route guidance terminal on the basis of the identification information.

12. A route guidance method comprising:
capturing, by a route guidance terminal, an image of a marker installed indoors and recognizing the marker in the captured image;
transmitting, by the route guidance terminal, identification information of the marker to a route guidance system and receiving an electronic map from the route guidance system; and
receiving, by the route guidance terminal, a destination, searching for the route from the current location to the destination, and outputting the route identified through the search.

13. The route guidance method of claim 12, wherein, in the recognizing of the marker, the route guidance terminal provides guidance on correcting a pose of an internal camera.

14. The route guidance method of claim 13, wherein the pose of the camera includes at least one of a distance between the camera and the marker, a location of the camera, an angle of the camera, a magnification of the camera, a photographing time of the camera, and a screen brightness of the camera.

15. The route guidance method of claim 12, wherein, in the searching for the route from the current location to the destination and outputting the route identified through the search, the route guidance terminal analyzes an image captured through a camera to detect the identification information of the marker, detects a location of the marker matching the identification information of the marker from the electronic map, and then measures a relative location with respect to the route guidance terminal based on the location of the marker to measure the current location of the route guidance terminal.

16. The route guidance method of claim 12, wherein, in the searching for the route from the current location to the destination and outputting the route identified through the search, the route guidance terminal searches for a route to the destination on the basis of a moving direction and distance of the route guidance terminal and outputs the route identified through the search.

17. The route guidance method of claim 16, wherein, in the searching for the route from the current location to the destination and outputting the route identified through the search, the route is re-searched for according to whether the route guidance terminal goes out of a preset route range on the basis of the moving direction and distance of the route guidance terminal, and the route identified through the re-search is output.

18. The route guidance method of claim 12, further comprising receiving, by the route guidance terminal, content from the route guidance system and outputting the received content.

19. The route guidance method of claim 18, wherein, in the receiving of the content from the route guidance system and outputting the received content, the route guidance terminal receives a keyword, searches for the content, and outputs the content identified through the search.

20. The route guidance method of claim 18, wherein, in the receiving of the content from the route guidance system and outputting the received content, the route guidance terminal selects content for which guidance is available on the electronic map based on the current location of the route guidance terminal and displays the selected content.
